(19) United States
(12) Patent Application Publication
(10) Pub. No.: US 2025/0204683 A1
(43) Pub. Date: Jun. 26, 2025

(54) DRIVE DEVICE FOR A FURNITURE FITTING OR BUILDING FITTING

(71) Applicant: Julius Blum GmbH, Hoechst (AT)

(72) Inventor: Pascal Janser, Hoechst (AT)

(21) Appl. No.: 19/079,858

(22) Filed: Mar. 14, 2025

Related U.S. Application Data
(63) Continuation of application No. PCT/AT2023/060346, filed on Oct. 4, 2023.

(30) Foreign Application Priority Data
Oct. 14, 2022 (AT) GM 50155/2022

(51) Int. Cl. A47B 88/46; E05F 1/16

(52) U.S. Cl. CPC A47B 88/46; E05F 1/16; E05Y 2201/22; E05Y 2201/499; E05Y 2900/20

(57) ABSTRACT

A drive device, preferably an ejection device, for a furniture fitting or a construction fitting includes a housing, an actuating device movable relative to the housing, and a spring for applying a force to the actuating device, with the spring having a first end connected to the actuating device. A bearing device supports a second end of the spring to the housing, and the bearing device is configured to be adjusted over a limited path relative to the housing.

The present application is a continuation of International Application PCT/AT2023/060346 filed on Oct. 4, 2023. Thus, all of the subject matter of International Application PCT/AT2023/060346 is incorporated herein by reference.

### BACKGROUND OF THE INVENTION

The present invention relates to a drive device, preferably an ejection device, for a furniture fitting or a construction fitting. In particular, the drive device includes at least one housing, at least one actuating device movable relative to the housing, at least one spring for applying a force to the at least one actuating device, the at least one spring being connected with a first end to the at least one actuating device, and at least one bearing device for supporting the at least one spring with a second end to the at least one housing.

Moreover, the invention relates to a furniture fitting or a construction fitting comprising a drive device of the type to be described.

Further, the invention concerns an item of furniture comprising a furniture carcass, a furniture part movably supported relative to the furniture carcass, and at least one drive device of the type to be described.

Such furniture drives are used, for example, to retract a movably supported furniture part into a closed end position relative to a furniture carcass and/or to eject the movable furniture part from a closed end position into an open position relative to a furniture carcass by a force of the spring. With furniture parts having a different size or a different weight, it is desirable that the force of the spring can be individually determined. For an operator, it is namely perceived as unpleasant when retraction forces and/or ejection forces acting on the movable furniture part are too large or too less. For heavy movable furniture parts, larger spring forces are required than for light furniture parts. For the case that an additional damping device is combined with the drive device in the form of a retraction device, the retraction force of the spring must be adapted correspondingly.

### SUMMARY OF THE INVENTION

It is an object of the present invention to propose a drive device mentioned in the introductory part, thereby avoiding the above-discussed drawbacks.

According to the invention, the at least one bearing device is configured to be adjusted over a limited path relative to the at least one housing.

In other words, a position of the bearing device to which the spring is fixed is adjustable to different positions relative to the housing. In this way, the maximum spring force as well as the spring deflection is adjustable, so that an individual adaptation of the spring force with respect to the furniture part to be moved can be made possible.

According to a preferred embodiment, the at least one bearing device is adjustable between a first position and at least a second position, the at least one spring being stronger tensioned in the second position than in the first position, and at least one release device is provided for resetting the at least one bearing device from the second position into the first position, preferably under the action of the at least one spring.

Such a release device is insofar beneficial, because the position of the bearing device is resettable with immediate effect into an initial position in which the spring is minimally tensioned. In this way, numerous rotations of a rotatably-supported actuating element for reducing the spring force can be omitted.

According to an embodiment, the release device can include at least one, preferably linearly, movable release element configured to be directly accessible for a manual actuation or for a tool-assisted actuation from a position outside the housing of the drive device.

The at least one bearing device is resettable from the second position into the first position by a manual or by a tool-assisted actuation, preferably under the action of the at least one spring.

As for the spring, preferably mechanical spring elements in the form of compression springs, tension springs or torsional springs can be employed.

### BRIEF DESCRIPTION OF THE DRAWINGS

Further details and advantages of the present invention will be explained with reference to the drawings, in which:

FIG. 1 is a perspective view of an item of furniture comprising a furniture carcass and a furniture part movably supported relative to the furniture carcass,

FIG. 2 is a perspective view of a furniture fitting in the form of a drawer pull-out guide comprising a drive device for driving the movable furniture part,

FIGS. 3a, 3b show a first embodiment of a drive device in a perspective view and in a top view,

FIG. 4a-4e show a temporal sequence of adjusting a spring force of the drive device according to FIGS. 3a, 3b,

FIGS. 5a, 5b show a second embodiment of a drive device in a perspective view and in a top view,

FIGS. 6a, 6b show a third embodiment of a drive device in a perspective view and in a top view,

FIG. 7a-7d show a temporal sequence of adjusting the spring force of the drive device according to FIGS. 6a, 6b,

FIGS. 8a, 8b show a fourth embodiment of a drive device in a perspective view and in a top view,

FIG. 9a-9c show a temporal sequence of adjusting the spring force of the drive device according to FIGS. 8a, 8b, and

FIG. 10a-10c show the drive device according to FIGS. 3a, 3b, 4a-4e in a slightly modified embodiment.

### DETAILED DESCRIPTION OF THE INVENTION

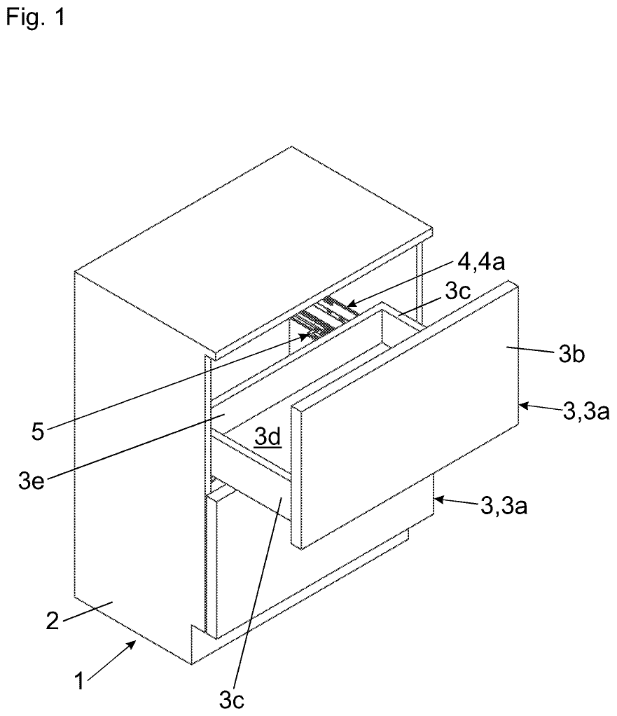

FIG. 1 shows a perspective view of an item of furniture 1 comprising a furniture carcass 2 and a furniture part 3 movably supported relative to the furniture carcass 2. In the shown embodiment, the movable furniture part 3 is movably supported relative to the furniture carcass 2 via at least one furniture fitting 4 in the form of a drawer pull-out guide 4a. Here, the movable furniture part 3 is in the form of a drawer 3a having a front panel 3b, sidewalls 3c, a drawer bottom 3d and a rear wall 3e.

By a drive device 5, the movable furniture part 3 is retractable into a closed end position relative to the furniture carcass 2 and/or is ejectable at least over a region from a closed end position relative to the furniture carcass 2 into an open position. For example, the drive device 5 can be in the form of a retraction device and/or in the form of an ejection device.

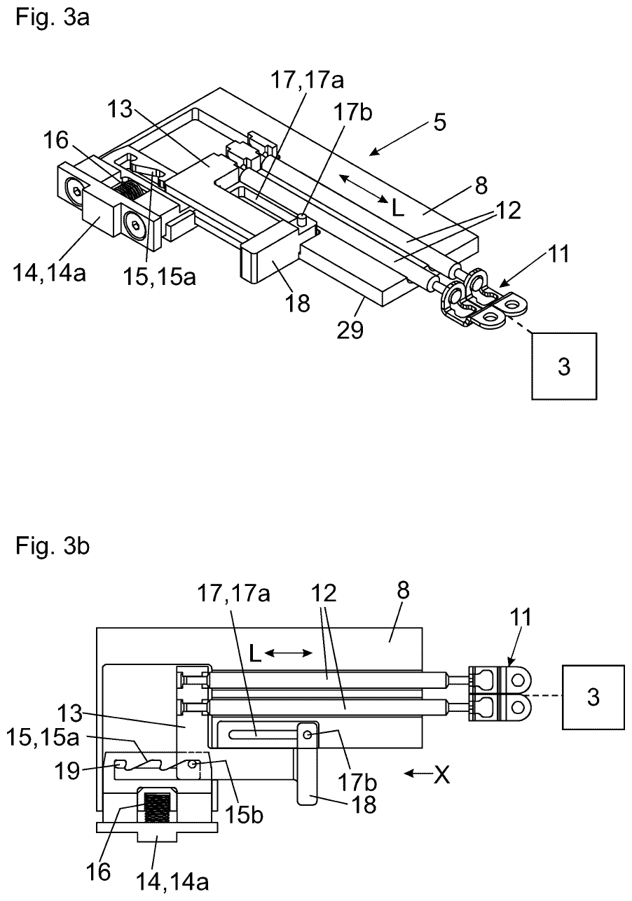

In the case of a retraction device, it is preferable that the drive device 5 includes a spring 12 (FIG. 3a) and an entrainment member, the entrainment member being pressurized by the spring 12 and being configured to be releasably coupled to the movable furniture part 3. The movable furniture part 3 is retractable into the closed end position by the entrainment member and by a force of the spring 12.

In the case of an ejection device, it is preferable that the drive device 5 includes a spring 12 (FIG. 3a), a movable ejection element pressurized by the spring 12, and a locking device configured to lock the ejection element in a locking position. The ejection element is unlockable by overpressing the movable furniture part 3 into an overpressing position located behind the closed position. The movable furniture part 3, with an unlocked ejection element, can be ejected in the opening direction by a force of the spring 12.

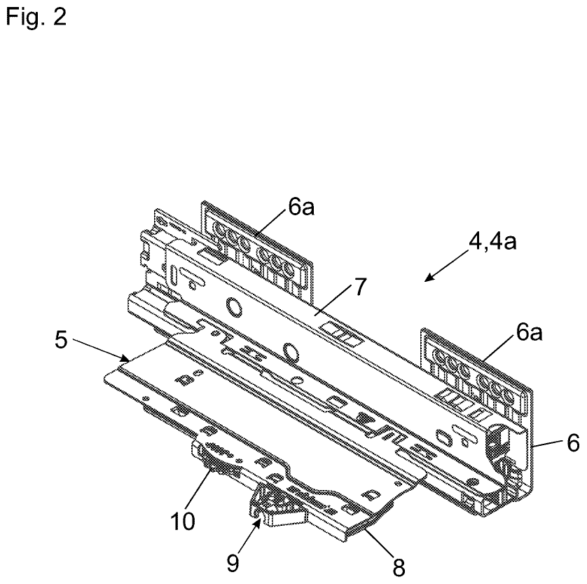

FIG. 2 shows a perspective view of a furniture fitting 4 in the form of a drawer pull-out guide 4a comprising a drive device 5 for driving the movable furniture part 3. The drawer pull-out guide 4a includes a carcass rail 6 configured to be fixed to the furniture carcass 2 via at least one fastening section 6a. Further, the drawer pull-out guide 4a includes at least one extension rail 7 displaceable relative to the carcass rail 6, the extension rail 7 being configured to be connected to the drawer 3a.

The drive device 5 for driving the movable furniture part 3 includes a housing 8, the housing 8 being connected or being configured to be releasably connected to the furniture fitting 4. Alternatively, the housing 8 of the drive device 5 can be integrated into the furniture fitting 4. In the shown embodiment, the drive device 5 includes a synchronization device 9, and a movement of the drive device 5 can be synchronized with a movement of a further drive device 5 arranged on an opposing side of the furniture carcass 2 via a synchronization rod (not shown here). By a rotatably supported adjustment wheel 10, a closed end position of the extension rail 7 (and therewith of the movable furniture part 3) is adjustable relative to the furniture carcass 2.

FIG. 3a shows a perspective view of a first embodiment of a drive device 5. The drive device 5 includes:
at least one housing 8,
at least one actuating device 11 movable relative to the housing 8,
at least one spring 12 for applying a force to the at least one actuating device 11, the at least one spring 12 being connected with a first end to the at least one actuating device 11,
at least one bearing device 13 for supporting the at least one spring 12 with a second end on the at least one housing 8.

The actuating device 11 is coupled or is configured to be releasably coupled to the movable furniture part 3 so as to transmit a movement of the actuating device 11 to the movable furniture part 3.

According to the invention, the at least one bearing device 13 is configured to be adjusted over a limited path relative to the at least one housing 8. In this way, the maximum spring force as 20 well as the spring deflection is adjustable, so that an individual adaptation of the spring force with respect to the furniture part 3 to be moved can made possible.

According to an embodiment, the at least one bearing device 13 is adjustable between a first position and at least a second position, the at least one spring 12 being stronger tensioned in 25 the second position than in the first position. At least one release device 14 is provided for resetting the at least one bearing device 13 from the second position into the first position, preferably under the action of the at least one spring 12.

According to possible embodiments, the at least one release device 14:
includes at least one, preferably sawtooth-shaped, locking contour 15a, and/or
includes at least one release position, in which the release device 14 unblocks the at least one bearing device 13, and a locking position, in which the release device 14 locks the at least one bearing device 13, and at least one spring element 15 is provided for pre-stressing the release device 14 relative to the housing 8 in a direction towards the locking position, and/or
is movably supported relative to the housing 8 in a direction extending transversely to a longitudinal direction L of the at least one spring 12, and/or
includes at least one release element 14a arranged outside the housing 8 and being configured to be manually actuated.

The release device 14 has the advantage that the at least one spring 12 is resettable with immediate effect to a minimal tension, without the need that numerous rotations of a rotatably supported adjustment element are necessary.

According to possible embodiments, the at least one bearing device 13:
is movable, preferably linearly displaceable, relative to the housing 8, and/or
is movably supported in a direction extending parallel to a longitudinal direction L of the at least one spring 12, and/or
is configured to be guided relative to the housing 8 via at least one guide device 17, preferably the guide device 17 including at least one guide track 17a and at least one guide element 17b configured to be engaged in the guide track 17a, and/or
is substantially L-shaped or substantially U-shaped, and/or
includes at least one actuating element 18 arranged outside the housing 8 and being configured to be manually actuated.

In the shown embodiment, the guide track 17a is arranged or formed on the housing 8, and the guide element 17b is arranged or formed on the bearing device 13. Of course, in a kinematic reversal, it is also possible to arrange the guide track 17a on the bearing device 13 and the guide element 17b on the housing 8. By a locking device 15, the at least one bearing device 13 is releasably lockable on the housing 8. For example, the locking device 15 can include at least one locking contour 15a and at least one locking element 15b configured to be engaged in the locking contour 15a.

The housing 8 includes a fastening surface 29 configured to bear against the furniture fitting 4 or configured to bear against a furniture part. The release element 14a of the release device 14 is movably supported in a plane extending parallel to the fastening surface 29 of the housing 8.

This has the particular advantage that the release element 14a of the release device 14 can be laterally actuated, and the drive device 5 can be produced in a very flat manner. The at least one bearing device 13 and the at least one release device 14 are configured as two constructional units movably supported on the housing 8 independently from each other.

By the actuating element 18 of the bearing device 13, the at least one spring 12 can be tensioned. By the release element 14a of the release device 14, the spring 12 can be relaxed, the release element 14a being separate from the actuating element 18. The actuating element 18 of the bearing device 13 is movably supported in a longitudinal direction L of the at least one spring 12, and in a direction extending parallel to the fastening surface 29 of the housing 8.

The release element 14a of the release device 14 is movably supported in a direction extending transversely to the longitudinal direction L of the at least one spring 12, and in a direction extending parallel to the fastening surface 29 of the housing 8.

FIG. 3b shows the drive device 5 according to FIG. 3a in a top view, in which the force of the spring 12 is adjusted to a minimum. For adjusting a position of the bearing device 13 relative to the housing 8, the actuating element 18 is to be pressed in the direction X. The locking element 15b is movable, against a force of the spring element 16, preferably of a compression spring, along the, preferably sawtooth-shaped, locking contour 15b and along a guide track 19 arranged on the housing 8. Preferably, the guide track 19 extends linearly and/or parallel to the longitudinal direction L of the spring 12. In this way, the locking element 15b is releasably lockable along the locking contour 15a on two or more predetermined positions, so as to adjust two or more different forces of the spring 12.

According to possible embodiments:
the locking element 15b is arranged on the at least one bearing device 13, and/or
the locking element 15b is substantially cylindrical, and/or
at least one guide track 19 arranged on the housing 8 is provided, the locking element 15b being guidable in the guide track 19.

According to possible embodiments, the locking contour 15a:
is movable, preferably linearly displaceable, relative to the housing 8, and/or
is movable relative to the housing 8 against a force of a spring element 16, and/or
is movable in a direction extending transversely to a movement direction of the bearing device 13, and/or
is sawtooth-shaped, wave-shaped or semicircular-shaped.

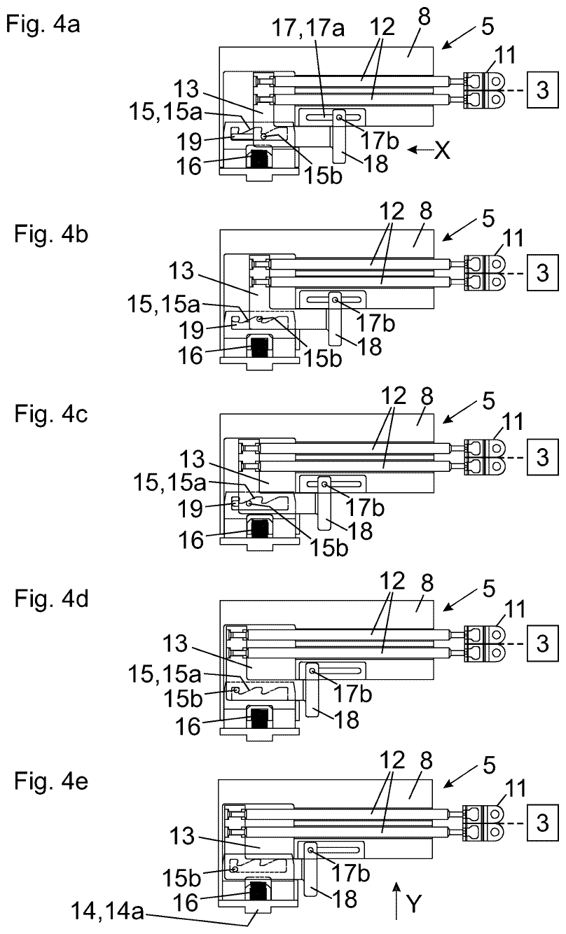

FIG. 4a-4e show a temporal sequence of adjusting a force of the spring 12 of the drive device 5 according to the embodiment of FIGS. 3a, 3b.

FIG. 4a shows that the position of the bearing device 13, from the first locking position of the locking element 15b according to previous FIGS. 3a, 3b in which the tension of the spring 12 was set to a minimum, is adjustable relative to the housing 8 by applying manual pressure to the actuating element 18 in the direction X.

For guiding the bearing device 13, at least one guide element 17b arranged on the bearing device 13 is provided. The guide element 17b is movable, preferably linearly displaceable, along a guide track 17a arranged on the housing 8. Moreover, the locking element 15b arranged on the bearing device 13 is guidable along the, preferably sawtooth-shaped, locking contour 15a of the housing 8. The locking element 15b is additionally guided along a, preferably linearly extending, guide track 19 of the housing 8. The guide element 17b and/or the locking element 15b can be substantially cylindrical.

FIG. 4b shows that the locking element 15b of the bearing device 13 is located in a second locking position, in which the tension of the spring 12 is increased in comparison with the first locking position of the locking element 15b according to FIGS. 3a, 3b.

FIG. 4c shows that the locking element 15b of the bearing device 13 is further guidable along the locking contour 15a of the housing 8 by a continued pressure application to the actuating element 18.

FIG. 4d shows that the locking element 15b of the bearing device 13 is located in a third locking position, in which the tension of the spring 12 is increased in comparison with the first locking position according to FIGS. 3a, 3b and in comparison with the second locking position according to FIGS. 4b.

Accordingly, in the shown embodiment, three different locking positions of the locking element 15b are provided, the three different locking positions defining three different tensions of the spring 12. Of course, more locking positions of the locking element 15b can also be provided. It is also possible to provide a continuous adjustability of the locking element 15b instead of predetermined locking positions. However, the predetermined locking positions have the advantage that the operator receives an assistance in selecting a suitable spring tension so as to make a fast adjustment of the spring force possible.

FIG. 4e shows that the release element 14a of the release device 14 has been moved against the force of the spring element 16 in a direction Y extending transversely to the longitudinal direction L of the spring 12. In this way, the locking element 15b is releasable from the locking contour 15a of the housing 8. The locking element 15b (jointly with the bearing device 13) can thus be resetted from the third locking position, due to the action of the spring 12, into a position in which the force of the spring 12 is set to a minimum (see FIGS. 3a, 3b).

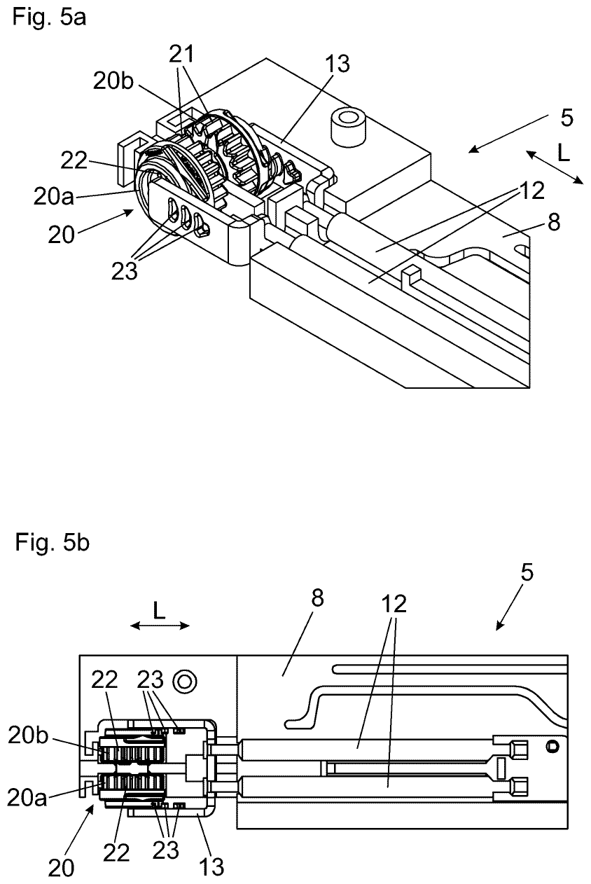

FIG. 5a shows a second embodiment of a drive device 5 with an adjustment device 20 for adjusting a position of the bearing device 13 relative to the housing 8.

According to possible embodiments, the adjustment device 20:
includes at least one adjustment wheel 20a, 20b, the adjustment wheel 20a, 20b being rotatably arranged on the housing 8 about an axis extending transversely to the longitudinal direction L of the at least one spring 12, and/or includes at least one circumferential actuating contour 21 which is arranged partially outside the housing 8 and which is configured for manual actuation, and/or
includes at least one spiral-shaped guide contour 22 co-operating with a plurality of protrusions 23 spaced apart from each other.

In the shown embodiment, the spiral-shaped guide contour 22 is arranged on the at least one adjustment wheel 20a, 20b, and the protrusions 23 co-operating with the guide contour 22 are arranged on the bearing device 13 which is movably-supported relative to the housing 8. Of course, the reverse arrangement is also possible here.

FIG. 5b shows the drive device 5 according to FIG. 5a in a top view. Here, the bearing device 13 is substantially C-shaped, and the at least one spring 12 is connected to the bearing device 13. By rotating an adjustment wheel 20a, 20b, a position of the bearing device 13 relative to the housing 8 in a direction of the longitudinal direction L of the spring 12 and thus the operative force of the spring 12 is adjustable. The at least one adjustment wheel 20a, 20b can be coupled to the bearing device 13 via a worm gear, and the protrusions 23 arranged on the bearing device 13 engage into a spiral-shaped guide track 22 of the adjustment wheel 20a, 20b.

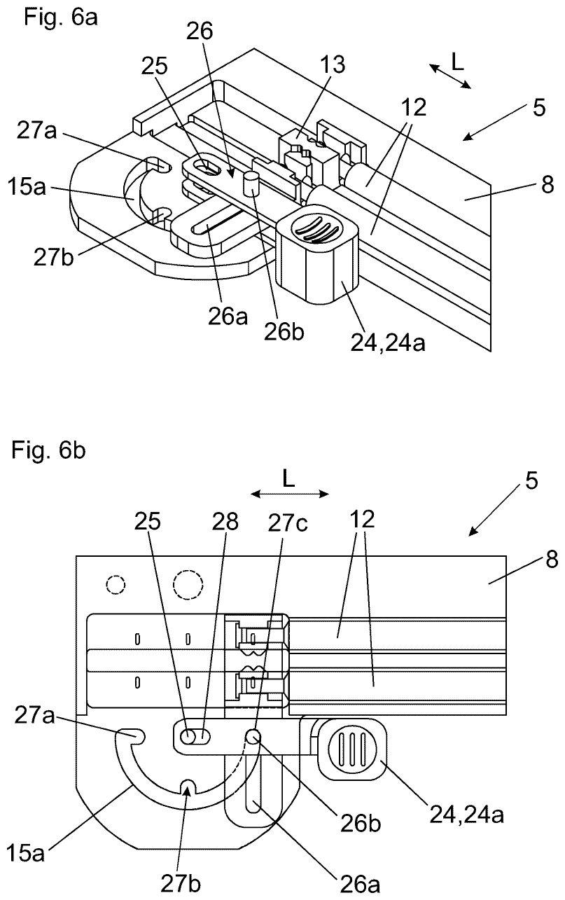

FIG. 6a shows a third embodiment of a drive device 5 comprising at least one pivot lever 24 for adjusting a position of the bearing device 13 relative to the housing 8.

According to possible embodiments, the at least one pivot lever 24:
includes at least one handle element 24a which is arranged outside the housing 8 and which is configured for manual actuation, and/or
is pivotally supported about an axis 25 on the housing 8, preferably over an angle range of approximately 180°, and/or
is linearly supported over a limited path on the housing 8, and/or
is coupled to the at least one bearing device 13 via at least one coupling device 26, the coupling device 26 preferably having at least one coupling contour 26a and at least one coupling element 26b configured to be engaged in the coupling contour 26a.

In the shown embodiment, the coupling contour 26a is arranged on the bearing device 13 and the coupling element 26b is arranged on the pivot lever 24. Of course, the reverse arrangement is also possible here.

The position of the bearing device 13 relative to the housing 8 is adjustable in a direction extending parallel to the longitudinal direction L of the spring 12 by a pivotal movement of the pivot lever 24 about the axis 25, and via the coupling device 26.

FIG. 6b shows the drive device 5 according to FIG. 6a in a top view. It can be seen that the axis 25 is guided in an elongated hole 28 of the pivot lever 24 with play, whereby the pivot lever 24 can be linearly supported on the housing 8 over a limited path.

The substantially semicircular-shaped locking contour 15a can include at least one locking section 27a, 27b, 27c, preferably two or more locking sections 27a, 27b, 27c, for releasably locking the pivot lever 24.

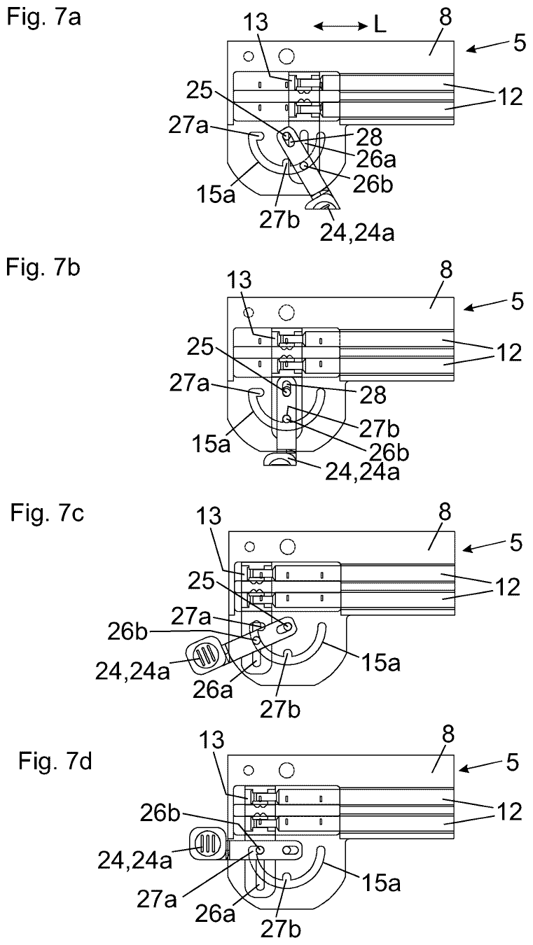

In the present case, three locking sections 27a, 27b, 27c are provided for releasably locking the pivot lever 24 in three different pivotal positions, and therewith three different prestress forces of the spring 12 are adjustable. For locking, the pivot lever 24 is to be manually moved into one of the locking sections 27a, 27b, 27c. The locking section 27a extends substantially parallel to a longitudinal direction L of the at least one spring 12. FIG. 7a-7d show a temporal sequence of adjusting the spring force of the drive device 5 according to FIGS. 6a, 6b.

FIG. 7a shows that the position of the bearing device 13 relative to the housing 8 is adjustable by a movement of the pivot lever 24 about the axis 25. The coupling element 26b of the pivot lever 24 is movable along the coupling contour 26a of the bearing device 13 and along the locking contour 15a of the housing 8.

FIG. 7b shows that the pivot lever 24 has been pushed into the locking section 27b. This linear movement can be made possible by the axis 25 movable within the elongated hole 28.

FIG. 7c shows a continued movement of the pivot lever 24 about the axis 25, in which the coupling element 26b of the pivot lever 24 is movable along the locking contour 15a of the housing 8.

FIG. 7d shows the coupling element 26b located within the locking section 27a. The locking section 27a extends substantially parallel to the longitudinal direction L of the spring 12, and the coupling element 26b of the pivot lever 24 can be retracted into the locking section 27b by the action of the spring 12.

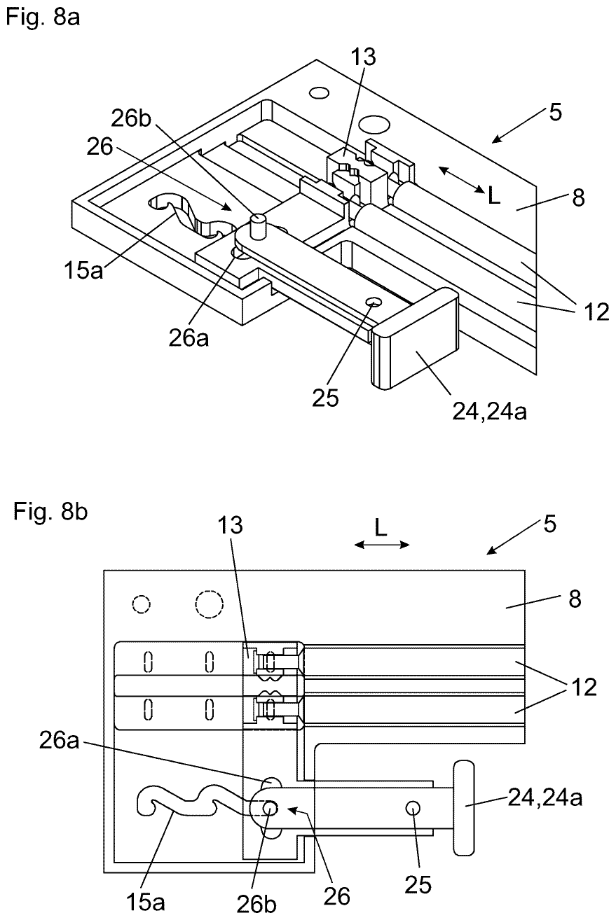

FIG. 8a shows a fourth embodiment of a drive device 5 with a pivot lever 24 for adjusting a position of the bearing device 13 relative to the housing 8.

According to possible embodiments, the pivot lever 24:
includes at least one handle element 24a which is arranged outside the housing 8 and which is configured for manual actuation, and/or
is coupled to the at least one bearing device 13 via at least one coupling device 26, the coupling device 26 preferably having at least one coupling contour 26a and at least one coupling element 26b configured to be engaged in the coupling contour 26a, and/or
is pivotally arranged about an axis 25 on the bearing device 13.

FIG. 8b shows the drive device 5 according to FIG. 8a in a top view.

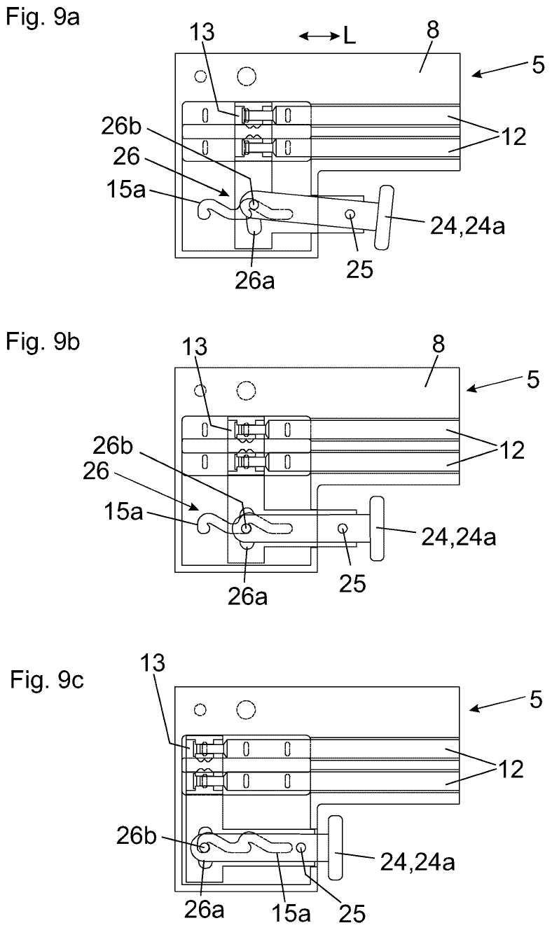

FIG. 9a-9c show a temporal sequence of adjusting the spring force of the drive device 5 according to FIGS. 8a, 8b, in which the pivot lever 24 is pivotally arranged about an axis 25 on the bearing device 13.

FIG. 9a shows that the coupling element 26b of the pivot lever 24 is movable along the locking contour 15a by manually applying a force to the pivot lever 24.

FIG. 9b shows that the coupling element 26b of the pivot lever 24 is movable into a first locking position by manually moving the pivot lever 24 about the axis 25. If appropriate, a locking spring can be used here so as to pressurize the pivot lever 24 in a direction of a locking position.

FIG. 9c shows that the coupling element 26b of the pivot lever 24 is movable into a further locking position, in which the spring 12 has a stronger tension than in FIG. 9b. By a movement of the pivot lever 24 about the axis 25 and by applying a manual pulling movement to the pivot lever 24, the locking between the pivot lever 24 and the locking contour 15a can be again released.

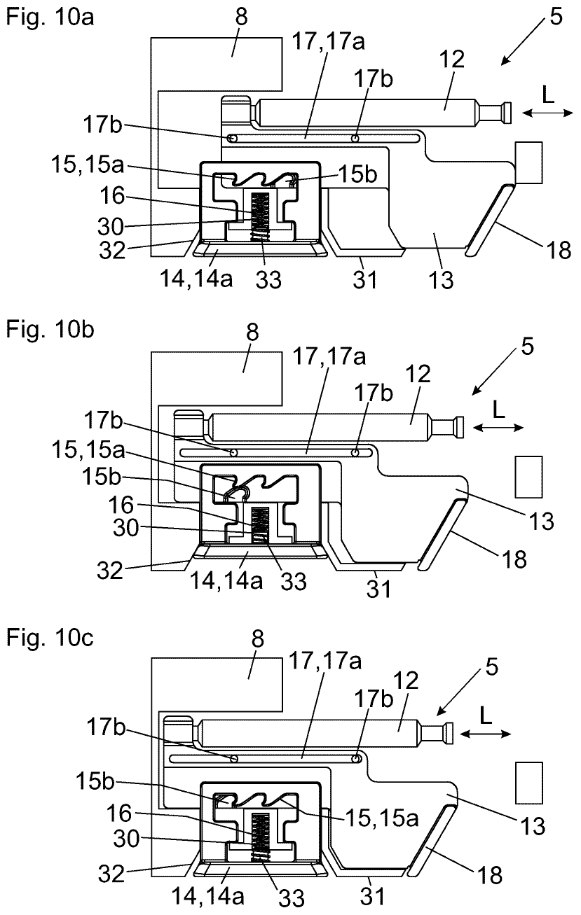

FIG. 10a-10c show the drive device 5 according to FIGS. 3a, 3b and FIGS. 4a-4e according to a slightly modified embodiment.

FIG. 10a shows the drive device 5 with the housing 8, the spring 12 for applying a force to the actuating device 11, and the bearing device 13 via which the at least one spring 12 is supported with an end on the housing 8. The bearing device 13 can be guided relative to the housing 8 via a guide device 17. In the shown embodiment, the guide device 17 includes two guide elements 17b separate from each other which can be guided along the guide track 17a. The housing 8 includes at least one recess 30 for at least partially receiving the spring element 16.

According to possible embodiments, the release element 14a of the release device 14:
is arranged substantially flush with an outer side 31 of the housing 8, and/or
includes at least one protrusion 33 configured to bear against the spring element 16, and/or
is configured to be countersunk in the housing 8, and/or
is configured to be arranged within a, preferably funnel-shaped, recess 32 of the at least one housing 8, and/or
is movably supported in a direction extending parallel to the fastening surface 29 (FIG. 3a) of the housing 8, and/or
is movably supported in a direction extending transversely to a longitudinal direction L of the at least one spring 12.

For adjusting a position of the bearing device 13 relative to the housing 8, the actuating element 18 is to be pressed in the longitudinal direction L of the spring 12. The locking element 15b is movable, against the force of the spring element 16, along the, preferably sawtooth-shaped, locking contour 15b. Preferably, the spring element 16 is a compression spring. In the shown embodiment, the locking element 15b has a counter-contour adapted to the locking contour 15a. In FIG. 10a, the locking element 15b is located on a first end of the locking contour 15a, and the force of the spring 12 is set to a minimum.

FIG. 10b shows a further position of the bearing device 13 relative to the housing 8, in which the locking element 15b is located on a tip of the sawtooth-shaped locking contour 15b.

FIG. 10c shows a further position of the bearing device 13 relative to the housing 8, in which the locking element 15b is located on a second end of the locking contour 15b, and the force of the spring 12 is set to a maximum.

The drive device 5 can be applied both to furniture fittings 4 in the form of drawer pull-out guides 4a and also to other types of furniture fittings 4, for example in the form of furniture hinges or actuating drives for flaps. Likewise, the usage in combination with construction fittings, for example for windows or doors, is also possible.

1. A drive device, preferably an ejection device, for a furniture fitting or a construction fitting, the drive device comprising:
at least one housing,
at least one actuating device movable relative to the housing,
at least one spring for applying a force to the at least one actuating device, the at least one spring being connected with a first end to the at least one actuating device,
at least one bearing device for supporting the at least one spring with a second end to the at least one housing,
wherein the at least one bearing device is configured to be adjusted over a limited path relative to the at least one housing.

2. The drive device according to claim 1, wherein the at least one bearing device is adjustable between a first position and at least a second position, wherein the at least one spring is stronger tensioned in the second position than in the first position, wherein at least one release device is provided for resetting the at least one bearing device from the second position into the first position, preferably under the action of the at least one spring.

3. The drive device according to claim 2, wherein:
the at least one release device is movably supported relative to the housing in a direction extending transversely to a longitudinal direction of the at least one spring, wherein the release device includes at least one release element which is arranged outside the housing and/or which is configured to be at least partially countersunk in the housing and configured for manual actuation, wherein the at least one bearing device is movably supported in a direction extending parallel to a longitudinal direction of the at least one spring, wherein the bearing device includes at least one actuating element separate from the at least one release element of the release device, the at least one actuating element being arranged outside the housing and being configured for manual actuation, and/or
the at least one bearing device and the at least one release device are configured as two constructional units movably supported independently from each other on the housing, and/or
the housing includes a fastening surface configured to bear against the furniture fitting or configured to bear against a furniture part, wherein the release device includes at least one release element movably supported in a plane extending parallel to the fastening surface of the housing.

4. The drive device according to claim 2, wherein the at least one release device:
includes at least one, preferably sawtooth-shaped, locking contour, and/or
includes at least one release position, in which the release device unblocks the at least one bearing device, and at least one locking position, in which the release device locks the at least one bearing device, wherein at least one spring element is provided for pre-stressing the release device relative to the housing into the locking position, preferably wherein the at least one housing includes at least one recess for at least partially receiving the spring element and/or wherein at least one release element of the release device is arranged substantially flush with an outer side of the housing.

5. The drive device according to claim 2, wherein the at least one release device:
is movably supported relative to the housing in a direction extending transversely to a longitudinal direction of the at least one spring, and/or
includes at least one release element which is arranged outside the housing and/or which is configured to be at least partially countersunk in the housing and configured for manual actuation, and/or
includes at least one release element movable against a force of a spring element so as to reset the at least one bearing device, and/or
includes at least one release element configured to be arranged in a, preferably substantially funnel-shaped, recess of the at least one housing, and/or
includes at least one release element having at least one protrusion configured to bear against a spring element.

6. The drive device according to claim 1, wherein the at least one bearing device:
is movable, preferably linearly displaceable, relative to the housing, and/or
is movably supported in a direction extending parallel to a longitudinal direction of the at least one spring.

7. The drive device according to claim 1, wherein the at least one bearing device:
is configured to be guided relative to the housing via at least one guide device, preferably wherein the guide device includes at least one guide track and a guide element configured to be engaged in the guide track, and/or
is substantially L-shaped or substantially U-shaped, and/or
includes at least one actuating element arranged outside the housing and being configured to be manually actuated, preferably wherein the at least one actuating element has a longitudinal extension extending transversely or extending obliquely to a longitudinal direction of the at least one spring.

8. The drive device according to claim 1, further comprising a locking device for releasably locking the at least one bearing device on the at least one housing, preferably wherein the locking device includes at least one locking contour and at least one locking element configured to be engaged in the locking contour.

9. The drive device according to claim 8, wherein:
the locking element is arranged on the at least one bearing device, and/or
the locking element is substantially cylindrical or having a counter-contour adapted to the locking contour, and/or
at least one guide track arranged on the housing is provided, the locking element being guidable in the guide track.

10. The drive device according to claim 8, wherein the locking contour:
is movable, preferably linearly displaceable, relative to the housing, and/or
is movable relative to the housing against the force of a spring element.

11. The drive device according to claim 8, wherein the locking contour:
is movable in a direction extending transversely to a movement direction of the bearing device, and/or
is sawtooth-shaped, wave-shaped or semicircular-shaped, and/or
includes at least one locking section extending substantially parallel to a longitudinal direction of the at least one spring.

12. The drive device according to claim 1, wherein at least one adjustment device is provided for adjusting the bearing device relative to the housing, preferably wherein the adjustment device:
includes at least one adjustment wheel, the adjustment wheel being rotatably arranged on the housing about an axis extending transversely to the longitudinal direction of the at least one spring, and/or includes at least one circumferential actuating contour which is arranged partially outside the housing and which is configured for manual actuation, and/or
includes at least one spiral-shaped guide contour co-operating with a plurality of protrusions spaced apart from each other.

13. The drive device according to claim 1, wherein at least one pivot lever is provided for adjusting the bearing device relative to the housing.

14. The drive device according to claim 13, wherein the at least one pivot lever:
includes at least one handle element which is arranged outside the housing and which is configured for manual actuation, and/or
is pivotally supported about an axis on the housing or on the bearing device, preferably over an angle range of approximately 180°, and/or
is linearly supported on the housing over a limited path, and/or
is coupled to the at least one bearing device via at least one coupling device, preferably wherein the coupling device includes at least one coupling contour and at least one coupling element configured to be engaged in the coupling contour.

15. A furniture fitting or a construction fitting comprising the drive device according to claim 1.

16. An item of furniture comprising:
a furniture carcass,
a movable furniture part movably supported relative to the furniture carcass, and
the furniture fitting according to claim 15 for driving the movable furniture part relative to the furniture carcass.
